(19) United States
(12) Patent Application Publication
(10) Pub. No.: US 2013/0262158 A1
(43) Pub. Date: Oct. 3, 2013

(54) PORTABLE DEVICE FOR HOTEL ROOM SELECTION AND CHECK-IN

(71) Applicant: Tuming You, Xiamen (CN)

(72) Inventor: Tuming You, Xiamen (CN)

(21) Appl. No.: 13/431,943

(22) Filed: Mar. 27, 2012

(51) Int. Cl. G06Q 10/02

(52) U.S. Cl. 705/5

(57) ABSTRACT

An apparatus for hotel room selection and check in includes a database, user interface, room key dispenser, and computer processor. The apparatus stores and displays images and descriptions of a hotel or parts of a hotel to help a person make a room selection. The apparatus includes a touch screen on which touch-sensitive graphical buttons are displayed to allow a person to set selection criteria, which are used by the processor as filter parameters. The filter parameters are applied, by the apparatus or an external system, to a hotel room data set to obtain information about one or more hotel rooms that meet the person's selection criteria.

### FIELD OF THE INVENTION

This invention relates generally to electronic devices having a touch-sensitive screen as a user interface and, more particularly, a portable device for hotel room check-in.

### BACKGROUND OF THE INVENTION

With the advent of automated teller machines (ATM) and systems for making purchases via Internet websites, consumers have become accustomed to making transactions without the aid of a person on the other side of a counter or service desk. There is now increasing consumer demand for self-service options in the hospitality industry which have traditionally focused on personal contact and service.

What is needed is a device that can provide people a user friendly way to select a hotel room, check-in, and pay, and obtain a room key.

### SUMMARY OF THE INVENTION

Briefly and in general terms, the present invention is directed to a device portable device for hotel room selection and a non-transitory computer readable medium.

In aspects of the present invention, a portable device comprises a database, a user interface including a display screen, and at least one computer processor in communication with the database and the display screen. The database stores instructions executable by the at least one computer processor for setting filter parameters for hotel room selection. The filter parameters are set according to user input from the user interface.

In aspects other aspects, the display screen is a touch screen controlled by the at least one computer processor to display touch-sensitive graphical buttons for setting the filter parameters.

In aspects other aspects, the at least one computer processor executes instructions for applying the filter parameters to a hotel room data set.

In other aspects the at least one computer processor selects, according to the filter parameters, a hotel room from a plurality of hotel rooms in the hotel room data set, and executes instructions for displaying on the display screen information about the selected hotel room.

In other aspects, the at least one computer processor receives the hotel room data set from an external system.

In other aspects, the hotel room data set is stored in the database and includes information on room availability and room rates of one or more hotels.

In other aspects, the database stores a hotel reservation module executable by the at least one computer processor for obtaining the hotel room data set from an external system.

In other aspects, the at least one computer processor transmits the filter parameters to an external system, and executes instructions for displaying on the display screen information about a hotel room selected from a plurality of hotel rooms.

In other aspects, the at least one computer processor receives a user identification code from the user interface and transmits the user identification code to an external system in order to match the identification code to a hotel reservation.

In other aspects, the database stores images and descriptions of a hotel or parts of a hotel.

In other aspects, the at least one computer processor controls a payment device reader. In some aspects, the at least one computer processor controls the payment device reader to obtain data from a payment device. In some aspects, the at least one computer processor transmits the data obtained from the payment device to an external system.

In other aspects, the at least one computer processor controls a room key dispenser storing a plurality of room keys. In some aspects, the at least one computer processor controls the room key dispenser to activate a room key. In some aspects, the at least one computer processor controls the room key dispenser to obtain a room key serial number from a room key stored within the room key dispenser. In some aspects, the at least one computer processor transmits the room key serial number to an external system. In some aspects, the at least one computer processor controls the room key dispenser to program a code to a room key stored within the room key dispenser. In some aspects, the at least one computer processor receives the code from an external system.

A non-transitory computer readable medium having a stored computer program embodying instructions, which when executed by a computer, causes the computer to drive a touch screen. The computer readable medium comprises instructions for performing any one or any combination of the above-described actions by the at least one computer processor.

The features and advantages of the invention will be more readily understood from the following detailed description which should be read in conjunction with the accompanying drawings.

### BRIEF DESCRIPTION OF THE DRAWINGS

FIG. 1 is a block diagram of an exemplary system having a portable device configured to allow a user to select a hotel room, check in, pay, and/or obtain a room key.

FIG. 2 is a block diagram of an exemplary system similar to that of FIG. 1.

FIG. 3 is a block diagram of an exemplary portable device configured to allow a user to select a hotel room, check in, pay, and/or obtain a room key.

FIG. 4 is a diagram of exemplary software stored in a computer of a portable device configured to allow a user to select a hotel room, check in, pay, and/or obtain a room key.

FIG. 5 is a table showing exemplary specifications for a portable device configured to allow a user to select a hotel room, check in, pay, and/or obtain a room key.

FIG. 6 is a flow diagram showing an exemplary method for selecting a hotel room, checking in, paying, and obtaining a room key.

FIG. 7 is a display screen layout showing an exemplary room selection graphical interface displayed on a touch screen of a portable device.

FIG. 8 is a display screen layout similar to that of FIG. 7, showing an exemplary image of a room meeting selection criteria or filter parameters set by person using the room selection graphical interface.

FIG. 9 is a display screen layout showing an exemplary confirmation graphical interface displayed on a touch screen of a portable device.

### DETAILED DESCRIPTION OF EXEMPLARY EMBODIMENTS

As used herein, the word “hotel” encompasses any lodging establishment having rooms available for stay, including without limitation a motel, inn, hostel, resort, single building, and multiple building complex.

As used herein, the word “portable” means capable of being easily carried and moved by a person.

The phrases “touch sensitive display screen,” “touch sensitive screen,” and “touch screen” are used interchangeably herein. With finger taps and movements on the touch screen, users are able to interact with a computer system without a conventional push-button keyboard and mouse input device. As used herein, a “touch screen” is an electronic visual display configured to detect the presence, location, and movement of a physical object within the display area of the touch screen. The physical object can be a finger, a stylus, or other utensil manipulated by a person. Object detection can be performed according to various technologies. Object detection can be accomplished with resistive, acoustic, infrared, near-infrared, vibratory, optical, surface capacitance, projected capacitance, mutual capacitance, and self-capacitance screen technologies. For example, detecting the presence, location, and movement of a physical object within the display area can include sensing a distortion of an electrostatic field of the screen, measurable as a change in capacitance due to physical contact with a finger or other electrical conductor. As a further example, object detection can include sensing disruption of a pattern or grid of electromagnetic beams without any need for actual physical contact with or touching of the display area.

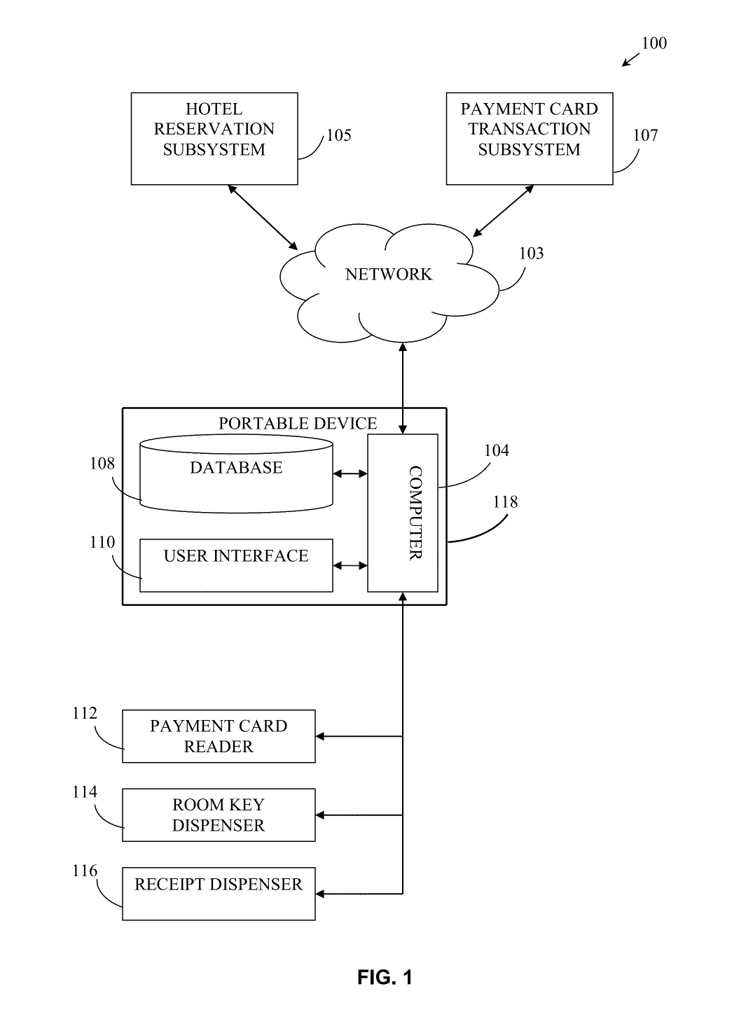

Referring now in more detail to the exemplary drawings for purposes of illustrating embodiments of the invention, wherein like reference numerals designate corresponding or like elements among the several views, there is shown in FIG. 1 an exemplary system 100 for selecting a hotel room, checking in, paying, and/or obtaining a room key. Portable device 118 helps people to select a room and provides a means for selecting a hotel room, checking in, paying, and obtaining a room key with or without the direct aid of or personal contact with another person.

In some embodiments, portable device 118 can be a smart phone, tablet personal computer (also referred to as an “electronic tablet”), personal digital assistant, or laptop personal computer. A smart phone is a mobile phone built on a mobile computing platform that allows the smart phone to have, in addition to telecommunications, any one of a combination of features including without limitation a media player, digital camera, web browser, global positioning system navigation, Wi-Fi and other wireless data communication. Portable device 118 can be used by a person (“guest”) wishing to stay at a hotel or used by another person (for example, a hotel employee) who is helping the guest check into a hotel.

Portable device 118 is in two-way communication via communications network 103 with hotel reservation subsystem 105 and payment card transaction subsystem 107. Network 103 can include any combination of conventional wire and wireless communication platforms, including but not limited to the Internet, local area networks, wide area networks, telephone networks, cable television networks, and satellite communication networks.

Hotel reservation subsystem 105 is a computerized system used by a hotel or agency to keep track of, manage, record, and make changes to data for room availability, room rates, and other hospitality services. Payment card transaction subsystem 107 is a computerized system used by a financial institution or agency to keep track of, manage, and record payments for financial transactions such as payments and credits for a hotel room and other hospitality services.

Hotel reservation subsystem 105 and payment card transaction subsystem 107 are referred to as external systems with which portable device 118 communicate to perform the functions described below. In other embodiments, portable device 118 communicates with other external systems when performing the functions described below.

Portable device 118 includes computer 104 having one or more processors configured to communicate with, operate, control, drive, and/or receive and send data from/to hotel reservation subsystem 105, payment card transaction subsystem 107, database 108, user interface 110, payment card reader 112, room key dispenser 114, and receipt dispenser 116. Two-way communication between computer 104 and user interface 110, payment card reader 112, room key dispenser 114 can be performed through any combination of conventional wire and wireless platforms. The one or more processors of computer 104 are configured to execute instructions stored in database 108.

Database 108 includes one or more volatile (transitory) and non-volatile (non-transitory) memory components for storing data. Data stored in volatile and non-volatile memory components of database 108 include without limitation images and descriptions of rooms, restaurants, bars, meeting rooms, amenities, and services provide by one or more hotels. Stored data can include information received from hotel reservation subsystem 105, such as room availability, room rates, and electronic codes for room keys. Stored data can further include information received from payment card transaction subsystem 107 and information conventionally used for making electronic payment transactions. Stored data can include instructions, executable by computer 104, for controlling user interface 110, payment card reader 112, room key dispenser 114, and receipt dispenser 116. The instructions can be parts or modules of software application programs stored in volatile and non-volatile memory components of database 108.

User interface 110 includes a touch screen.

Payment card reader 112 includes any one or a variety of devices for receiving and/or transferring data from/to a computer readable medium of a payment device. Non-limiting examples of a payment device include a credit card, debit card, smart phone, and objects having a computer readable medium, such as a magnetic strip, radio frequency identification (RFID) tag, near field communication (NFC) tag, and/or an electronic chip for making a financial transaction.

Room key dispenser 114 includes a receptacle for holding a plurality of room keys, a device for receiving and/or transferring data from/to a room key, and a device for dispensing a room key from the receptacle. The room key can be a device having a computer readable medium, such as a magnetic strip, radio frequency identification (RFID) tag, near field communication (NFC) tag, and/or an electronic chip storing data that uniquely identifies the room key.

Receipt dispenser 116 includes a device configured to print a record of a transaction, such as a payment or credit for a hotel room and other hospitality services.

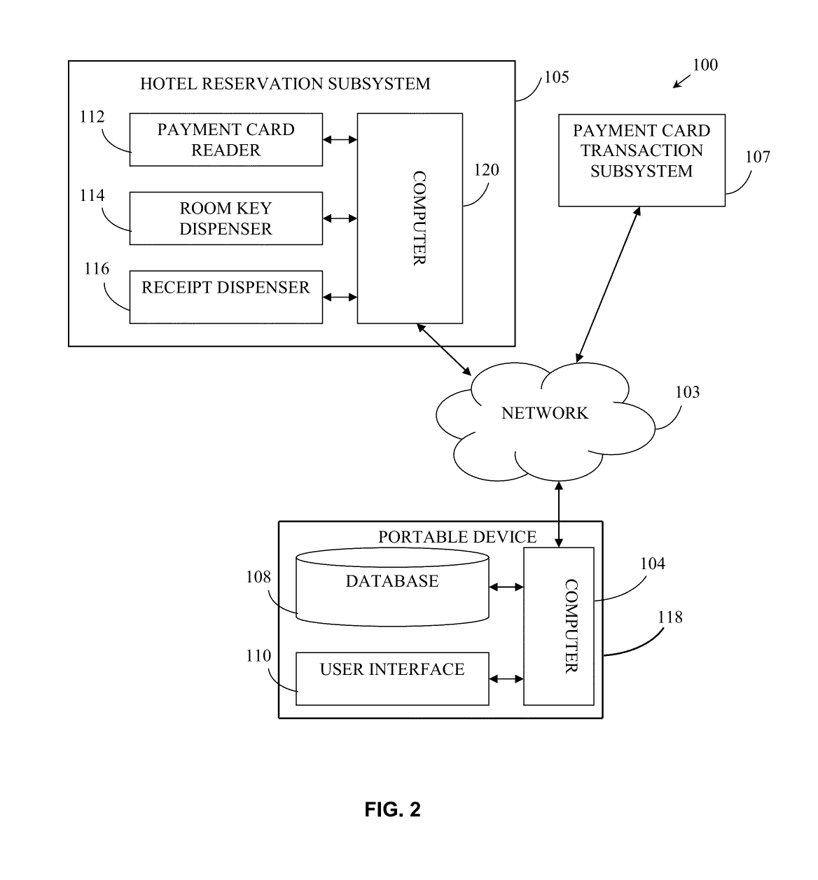

In other embodiments as shown in FIG. 2, payment card reader 112, room key dispenser 114, and receipt dispenser 116 are parts of hotel reservation subsystem 105. Computer 120 of hotel reservation subsystem 105 includes one or more processors configured to communicate with, operate, control, drive, and/or receive and send data to, payment card reader 112, room key dispenser 114, and receipt dispenser 116. The one or more processors of computer 120 are configured to execute instructions stored in a non-volatile (non-transitory) memory device coupled to computer 120. It will be appreciated that modifications can be made to system 100 of FIGS. 1 and 2 without departing from the scope of the invention.

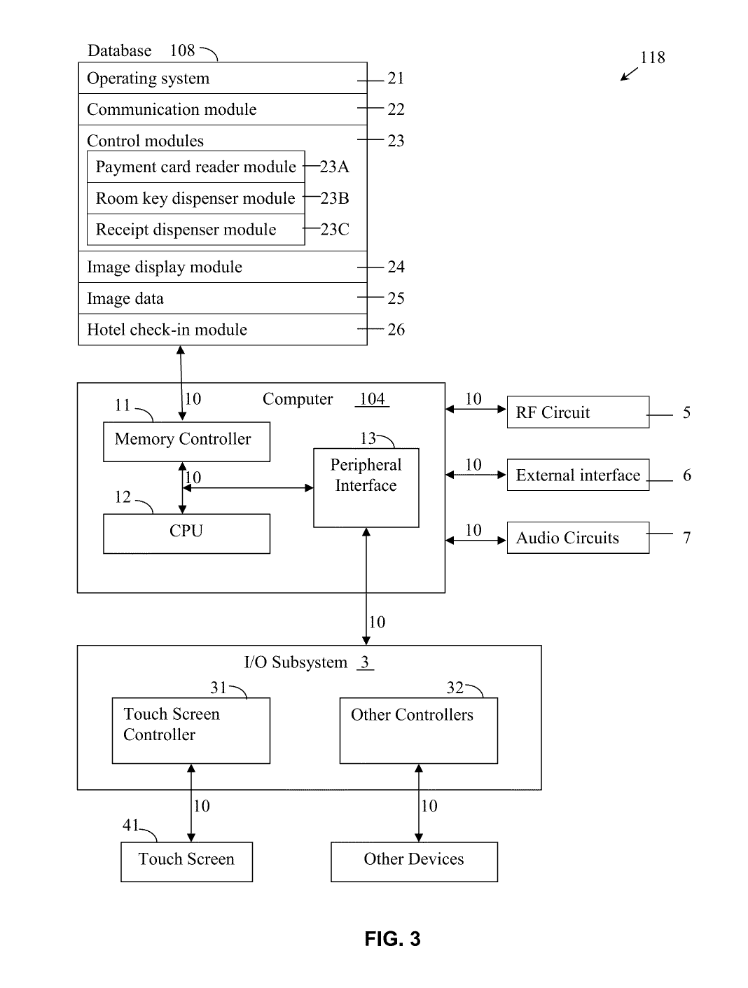

FIG. 3 shows an exemplary configuration for device 118 of FIG. 1. Computer 104 includes memory controller 11, processor (CPU) 12, and peripheral interface 13. Database 108 is a single or multiple coupled volatile (transitory) and non-volatile (non-transitory) memory devices/components, including without limitation magnetic disk storage devices, flash memory devices, and other non-volatile solid-state memory. Software programs and image data 25 are stored in volatile and non-volatile memory devices/components of database 108. The stored software programs include operating system 21, communication module 22, control modules 23, image display module 24, and hotel check-in module 26. Control modules 23 include payment card reader module 23A, room key dispenser module 23B, and receipt dispenser module 23C for controlling payment card reader 112, room key dispenser 114, and receipt dispenser 116. Software programs stored in database 108 may include a hotel reservation module for interacting with and communicating (transmitting and receiving) data from hotel reservation subsystem 105 (FIGS. 1 and 2), and a payment card transaction module for interacting with and communicating (transmitting and receiving) data from payment card transaction subsystem 107 (FIGS. 1 and 2).

Input/output (I/O) subsystem 3 includes touch screen controller 31 and other input controller 32 for other devices, such as payment card reader 112, room key dispenser 114, and receipt dispenser 116. Computer 104 is connected to RF circuit 5, external interface 6 and audio circuit 7. External interface 6 and/or RF circuit 5 can be coupled to network 103 (FIGS. 1 and 2). Connections through signal bus 10 allow each of the above components to communicate with each other through any combination of a physical electrical connection and a wireless communication connection.

It will be appreciated that modifications can be made to portable device 118 without departing from the scope of the invention. For example, in some embodiments, any one or a combination of memory controller 11, processor 12, and peripheral interface 13 can be implemented in a single chip or multiple chips. In some embodiments, some or all of the memory components of database 108 can be implemented on a single chip with any one or a combination of memory controller 11, processor 12, and peripheral interface 13. As a further example, control modules for payment card reader 112, room key dispenser 114, and receipt dispenser 116 can be omitted from portable device 118 of FIG. 2 and stored in a non-volatile (non-transitory) memory device coupled to computer 120 of hotel reservation subsystem 105 (FIG. 2).

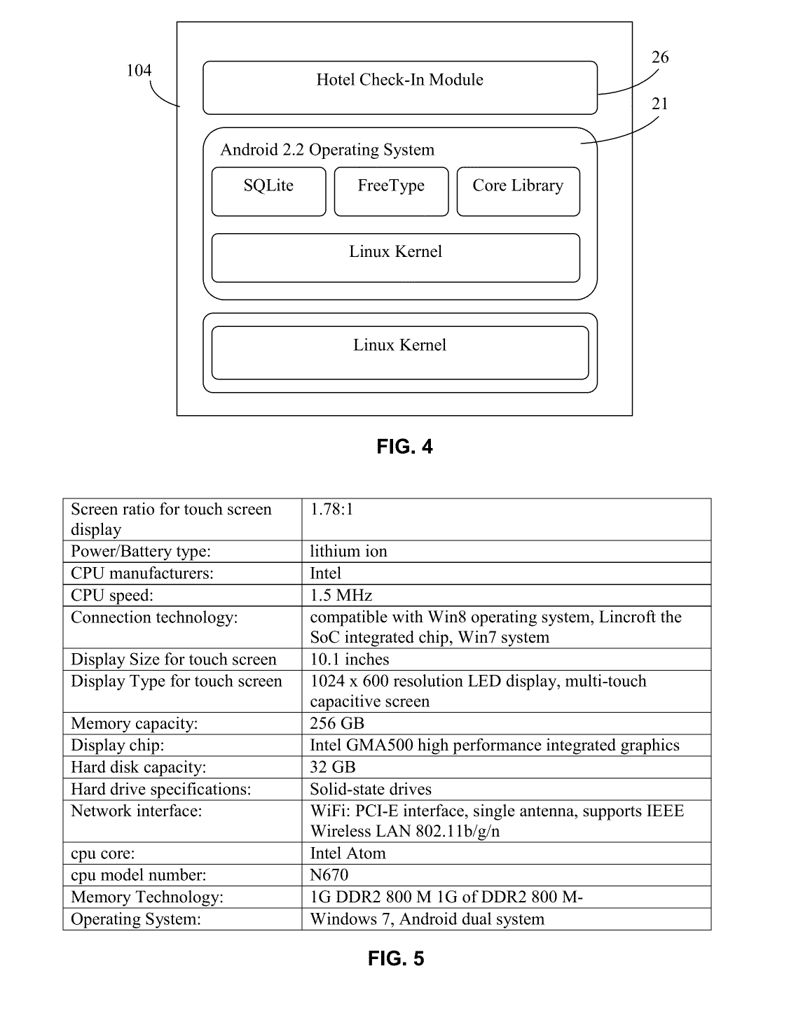

FIG. 4 shows a diagrammatic view of exemplary software stored in computer 104 of portable device 118. Computer 104 is equipped with hotel check-in module 26, an Android operating system 21, SQLite relational database management system, and FreeType software library for rendering. FIG. 5 shows exemplary specifications for portable device 118 containing computer 104.

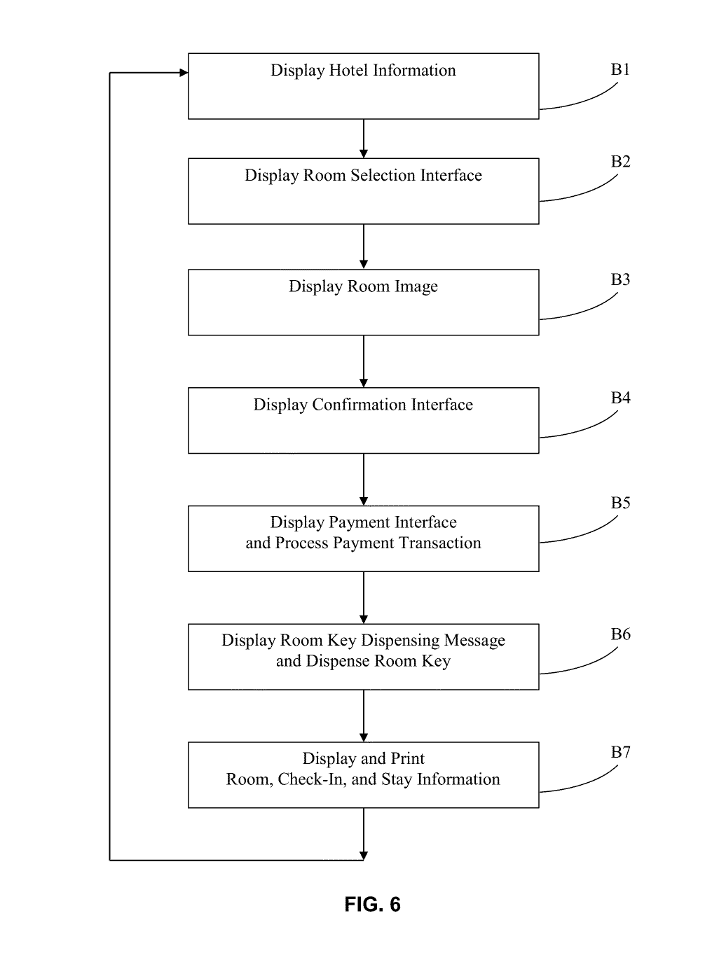

FIG. 6 shows a flow diagram of an exemplary method. Although the method is described according to components and features of portable device 118, it will be appreciated that the method is not limited to portable device 118. The functions described below can be implemented by instructions executed by one or processors of computer 104 of portable device 118 and/or computer 120 of hotel reservation subsystem 105. The instructions can be part of software modules described above in connection with FIG. 3.

Portable device 118 displays hotel information on touch screen 41 (Block B1). Hotel information can be a graphics slide show or animation showing images and text descriptions of the hotel exterior, local and nearby attractions, location and map, room accommodations, amenities, restaurants, bars, meeting facilities, and other services offered by one or more hotels. A touch-sensitive graphical button, for choosing a room, is simultaneously displayed on touch screen 41. Computer 104 detects when a person touches the graphical button and, in response, causes a room selection graphical interface to be displayed on touch screen 41 (Block B2).

If the person has made a prior reservation, the person may be prompted on touch screen 41 to enter an identification number, which can be a passport number, social security number, or credit card number. The identification number is one which was previously associated with a prior reservation. Entry of the identification number, made by the person on touch screen 41, initiates the process by which the person checks into the hotel. The identification number is communicated by computer 104 to hotel reservation subsystem 105 in order to match the identification number to the prior reservation.

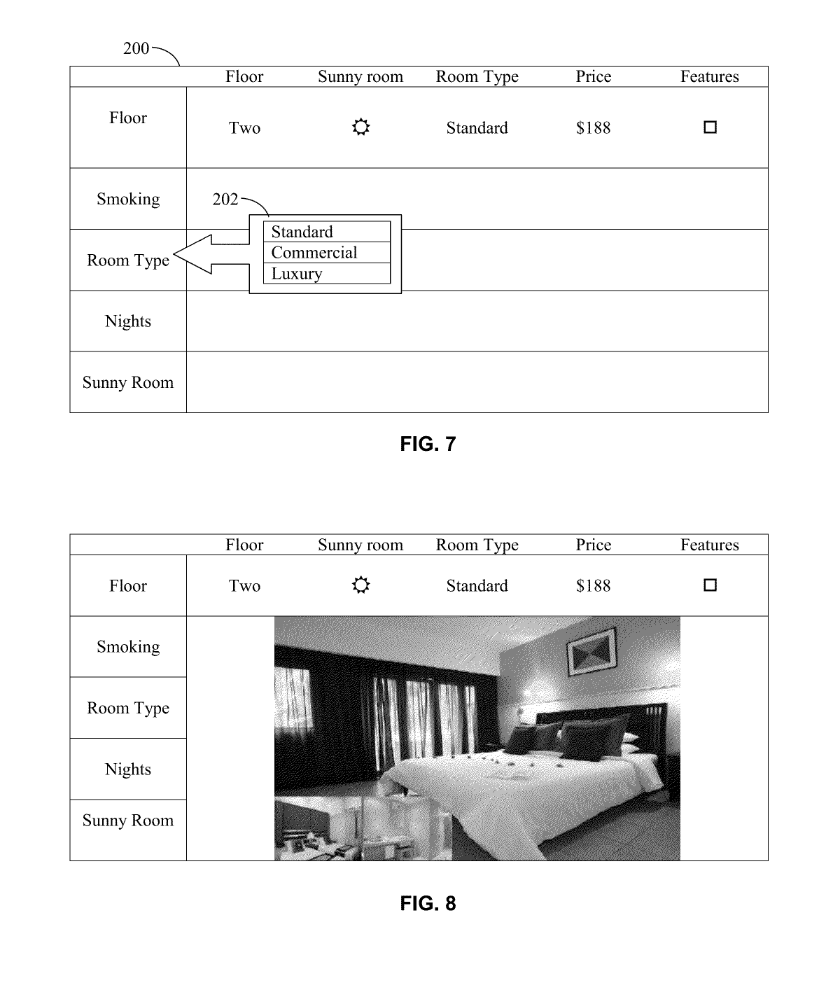

FIG. 7 shows exemplary room selection graphical interface 200 having multiple touch-sensitive graphical buttons that allow a person to specify a desired type of room and other details. Room selection graphical interface 200 has a plurality of touch-sensitive graphical buttons that allow a person to select the floor level on which the room is located, select a room in which smoking is permitted, select a comfort level for the room (such as standard, commercial, or luxury), select or change dates and/or a number of nights the person wishes to occupy the room, and select whether the room receives direct sunlight. There can also be a touch-sensitive graphical button to select or change an occupancy number (such as the number of beds in the room). The touch-sensitive graphical buttons, when touched by a person, result in a touch-sensitive options menu 202. The touch-sensitive graphical buttons and menu allow the person to set parameters for a filter that is applied to hotel room data set. The parameters are, in effect, the person's room selection criteria.

In some embodiments, a hotel room data set is obtained by computer 104 from hotel reservation subsystem 105 (FIGS. 1 and 2) before any of Block 1 and Block 2. Hotel room data set includes information for all possible rooms and options. Hotel room data set is stored in database 108. Next, after filter parameters have been set by the person from room selection graphical interface 200, computer 104 applies the filter to the hotel room data set to obtain information (e.g., room number, images, price, etc.) about the rooms that meet the filter parameters.

In some embodiments, computer 104 of portable device 118 executes instructions for selecting a hotel room from among a plurality of hotel rooms in the hotel room data set. The selection is made by computer 104 according to the filter parameters provided by the user through room selection graphical interface 200. Computer 104 also executes instructions for displaying information about the selected hotel room on the display screen of user interface 110. The instructions for selecting and displaying can be stored in non-volatile memory devices/components of database 108.

In alternative embodiments, the hotel room data set is not obtained by computer 104 from hotel reservation subsystem 105 or other external system. After filter parameters have been set by the person from room selection graphical interface 200, computer 104 sends the filter parameters to hotel reservation subsystem 105. Hotel reservation subsystem 105 applies the filter to the hotel room data set, then sends to computer 104 only the information (e.g., room number, images, price, etc.) about the rooms that meet the filter parameters.

The information about the rooms that meet the filter parameters is displayed on touch screen 41, as shown for example in FIG. 8 (Block B3). If more than one room meets the filter parameters, the person may select a particular room using a touch-sensitive graphical button on touch screen 41.

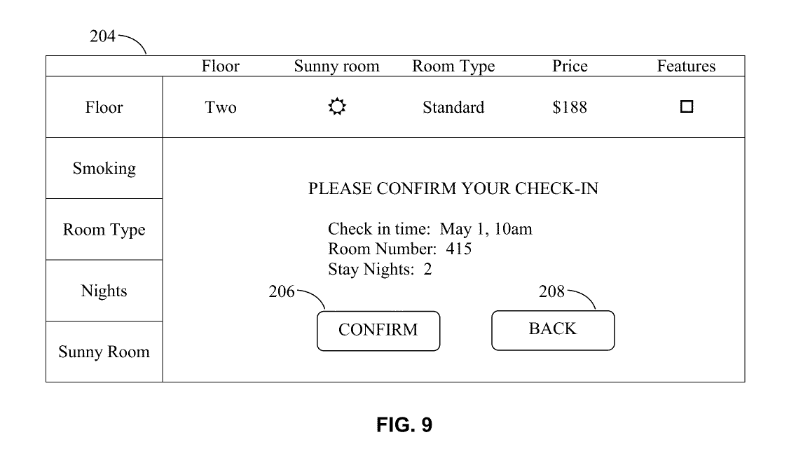

After making the room selection, computer 104 causes a confirmation graphical interface to be displayed on touch screen 41 (Block B4). Exemplary confirmation graphical interface 204 is shown in FIG. 9. Confirmation graphical interface 204 includes touch-sensitive graphical buttons 206, 208 to allow the person to verify or confirm the prior room selection or to go back to Block B2 to change the room selection.

After receiving confirmation from the person of the room selection, computer 104 causes a payment graphical interface to be displayed on touch screen 41 (Block B5) for processing of a payment transaction. Payment graphical interface may include a message for the person to place a payment card or payment device in or adjacent payment card reader 112 (FIGS. 1 and 2) to allow data to be obtained from the payment card/payment device, and may include touch-sensitive graphical buttons to allow the person to enter a personal identification number (PIN) or other verification code associated with the payment card/payment device.

Based on data obtained from the payment card/payment device and the room selection, computer 104 communicates with payment card transaction subsystem 107 (FIGS. 1 and 2) to initiate or record a payment transaction. In some embodiments, computer 104 does not communicate with payment card transaction subsystem 107 (FIGS. 1 and 2) until after check out. In some embodiments, the payment transaction is not completed until after the check-out.

After processing the payment transaction (which may only be recorded but not completed), computer 104 causes a room key dispensing graphical interface to be displayed on touch screen 41 (Block B6). Room key dispensing graphical interface may include touch-sensitive graphical buttons to allow the person to select the number of keys the person desires and may include a message informing the person to wait to obtain a room key from room key dispenser 114. Computer 104 also causes room key dispenser 114 (FIGS. 1 and 2) to select and eject a room key from the plurality of room keys stored in room key dispenser 114. Before the room key is ejected, room key dispenser 114 may activate a room key. Room key activation may include sending a room key serial number to hotel reservation subsystem 105 and/or programming the room key with a code obtained from hotel reservation subsystem 105.

After the room key is dispensed, computer 104 causes information to be displayed on touch screen 41 and printed out of receipt dispenser 116 (Block B7). The information may include any combination of the hotel address, map, room number, dates and times for room check in and check out, and telephone number for assistance.

In alternative embodiments, no payment card reader is used. A payment module is stored in a non-volatile component of database 108 and/or non-volatile component coupled to computer 120. The payment module includes instructions executable by one or more processors of computer 104 and/or computer 120 which causes a payment graphical interface to be displayed on touch screen 41. The payment graphical interface prompts a person to enter payment information, such as a credit card number, debit card number, PIN, other codes, and/or billing information used for payment which are transmitted to an external system, such as payment card transaction subsystem 107.

In alternative embodiments, user interface 110 includes a display screen and keyboard and/or touch pad located outside of the display area of the display screen. The touch-sensitive graphical buttons described above are replaced by pushbuttons on the keyboard.

In alternative embodiments, any of Blocks B1, B5 and B6 of FIG. 6 are omitted. For example, a method may proceed from Block B4 to Block B7 without performing Blocks B5 and B6. After receiving confirmation from the person of the room selection in Block 54, computer 104 causes information to be displayed on touch screen 41 and printed out of receipt dispenser 116 (Block B7). The information may include any combination of the hotel address, map, room number, dates and times for room check in and check out, and telephone number for assistance.

While several particular forms of the invention have been illustrated and described, it will also be apparent that various modifications can be made without departing from the scope of the invention. It is also contemplated that various combinations or subcombinations of the specific features and aspects of the disclosed embodiments can be combined with or substituted for one another in order to form varying modes of the invention. Accordingly, it is not intended that the invention be limited, except as by the appended claims.

What is claimed is:

1. A portable device for hotel room selection, comprising:
a database;
a user interface including a display screen; and
at least one computer processor in communication with the database and the display screen, wherein
the database stores instructions executable by the at least one computer processor for setting filter parameters for hotel room selection, the filter parameters set according to user input from the user interface.

2. The portable device of claim 1, wherein the display screen is a touch screen controlled by the at least one computer processor to display touch-sensitive graphical buttons for setting the filter parameters.

3. The portable device of claim 1, wherein the at least one computer processor executes instructions for applying the filter parameters to a hotel room data set.

4. The portable device of claim 3, wherein the at least one computer processor selects, according to the filter parameters, a hotel room from a plurality of hotel rooms in the hotel room data set, and executes instructions for displaying on the display screen information about the selected hotel room.

5. The portable device of claim 3, wherein the at least one computer processor receives the hotel room data set from an external system.

6. The portable device of claim 3, wherein the hotel room data set is stored in the database and includes information on room availability and room rates of one or more hotels.

7. The portable device of claim 6, wherein the database stores a hotel reservation module executable by the at least one computer processor for obtaining the hotel room data set from an external system.

8. The portable device of claim 1, wherein the at least one computer processor transmits the filter parameters to an external system, and executes instructions for displaying on the display screen information about a hotel room selected from a plurality of hotel rooms.

9. The portable device of claim 1, wherein the at least one computer processor receives a user identification code from the user interface and transmits the user identification code to an external system in order to match the identification code to a hotel reservation.

10. The portable device of claim 1, wherein the database stores images and descriptions of a hotel or parts of a hotel.

11. The portable device of claim 1, wherein the at least one computer processor controls a payment device reader.

12. The portable device of claim 11, wherein the at least one computer processor controls the payment device reader to obtain data from a payment device.

13. The portable device of claim 12, wherein the at least one computer processor transmits the data obtained from the payment device to an external system.

14. The portable device of claim 1, wherein the at least one computer processor controls a room key dispenser storing a plurality of room keys.

15. The portable device of claim 14, wherein the at least one computer processor controls the room key dispenser to activate a room key.

16. The portable device of claim 14, wherein the at least one computer processor controls the room key dispenser to obtain a room key serial number from a room key stored within the room key dispenser.

17. The portable device of claim 16, wherein the at least one computer processor transmits the room key serial number to an external system.

18. The portable device of claim 14, wherein the at least one computer processor controls the room key dispenser to program a code to a room key stored within the room key dispenser.

19. The portable device of claim 18, wherein the at least one computer processor receives the code from an external system.
